(19) United States
(12) Patent Application Publication
(10) Pub. No.: US 2009/0032517 A1
(43) Pub. Date: Feb. 5, 2009

(54) Ski integrated solar power system

(76) Inventors: Michael Dominic Sopuch, Missoula, MT (US); Clinten Edward Gundelfinger, Missoula, MT (US)

Correspondence Address: Michael Sopuch or Clinten Gundefinger, 2116 Jasmine Place, Missoula, MT, 59801, US

(21) Appl. No.: 11/888,574

(22) Filed: Aug. 1, 2007

(51) Int. Cl. H05B 1/00; A63C 5/06

(52) U.S. Cl. 219/202

(57) ABSTRACT

A system for heating a ski boot or snowboard boot powered by way of photovoltaic (solar) cells banked in a flexible solar panel or flexible solar panels placed within the structure of a ski or snowboard. Electricity produced by the photovoltaic cells is conducted from the solar panel(s) to the ski boot or snowboard boot via a circuit which is run from the solar panel(s) through the structure of the ski or snowboard to a contact point within or at the surface of the ski. The aim of which is to power a temperature controlled, heating element containing boot and/or binding and its circuitry, resulting in solar powered heat for the wearer.

### REFERENCES CITED

U.S. Patent documents

| | | |
|---|---|---|
| 4697360 | October 1987 | Sartor |
| 4780968 | November 1988 | Bragagnolo |
| 4798933 | January 1989 | Annovi |
| 4950858 | August 1990 | Slenker |
| 5041717 | August 1991 | Shay |
| 5140131 | August 1992 | Macher |

### FIELD OF THE INVENTION

The present invention relates to ski and snowboard boots, ski and snowboard bindings, skis, snowboards, their related apparati, solar (photovoltaic) energy, and heating apparati, where the significance of aforementioned products pertains to the heating of ski and snowboard boots.

### BACKGROUND OF THE INVENTION

Over the history of skiing and snowboarding the chief complaint of all participants from the most novice to the extremely skilled has been that of cold feet. Over the years many ideas on how to heat the boots of the ski and snowboard enthusiast have been attempted with marginal success. One of the more popular methods included a boot mounted battery pack and heating coil placed within the boot. The coil is uncomfortable to the wearer, pushing on the bones and veins of the foot, and the battery pack is cumbersome and inconveniently located on the boot, not to mention the heat is short-lived. Another popular product used to heat boots are chemical type heating packets stuffed into the boot immediately prior to wearing. This method is also uncomfortable for the same reasons as the aforementioned method, and the heat likewise short-lived. A third and somewhat more useful product are heated wool socks. These socks are laden with the same thermo coil as the first method mentioned. The socks likewise employ a similarly cumbersome battery pack energy source near the top of the sock, and above the ski boot.

To speak of other inventions relating to our idea, there are a scant few. Although in patents of those numbered: U.S. Pat. No. 4,780,968 by Bragagnolo; U.S. Pat. No. 4,798,933 by Annovi; U.S. Pat. No. 5,140,131 by Macher; U.S. Pat. No. 5,041,717 by Shay; and U.S. Pat. No. 4,950,858 by Slenker, ski boot heaters and their power sources are referenced, in all of these five, and some so slightly related they are not worth mention, all patents' claimed employing a battery type power pack or power source. Although in U.S. Pat. No. 5,041,717 Shay describes circuitry connection similar in scope to our invention, only in U.S. Pat. No. 4,697,360 by Leo Sartor is the arena of solar cells for powering ski boot heaters entered. In this patent the solar cells are wrapped around or covering the ski boot in some fashion. This patent is from 1987. Solar cells of that era were brittle and severely underpowered compared with today's models. This invention, if employed would probably have frozen and broken, or been sliced by the opposite ski edge in very short order.

All of these approaches attempted and fell short of the goal of keeping skiers and snowboarders happy and enjoying their sport while addressing practical powering issues. The present invention addresses the need and desire for skiers and snowboarders to have warm feet with a simple powering system, and thus concentrate on their sport and not fixate on how uncomfortable they are.

The present invention eliminates the need for external battery packs. Our invention also eliminates the short-lived heating of it's predecessors by employing a continuous flow of power to the heating elements. Present day flexible solar cells are extremely thin and can operate in low light, high sun, overcast and cloudy days while maintaining a regular flow of DC electricity. The top of the ski, in most cases, will be facing the sky. Added to which, the snow is reflecting light everywhere around the skier. On ski lifts, where cold feet become increasingly bothersome due to lack of blood flow, the skis are most definitely facing the sun and are gathering the necessary solar energy. Powering the system will not be a problem. Current heating element technologies will also allow a manufacturer utilizing our invention to employ thinner, more flexible and thus more comfortable heating elements in the boot. Although we are not making any specific claims about the heating elements within the boots, we are aware of such type of heat tape that may be preferred by a manufacturer of boots to be used with our powering system. The present invention revolutionizes, streamlines, and simplifies the process of heating ski and snowboard boots.

### SUMMARY OF THE INVENTION

The primary purpose of the invention is to provide a method and apparatus for heating ski and snowboard boots using solar energy from the sun captured by photovoltaic cells and delivering said energy along an electrical circuit whose purpose is to power heating elements within the boots interior composition. The method provides for the creation of a product that simplifies ski and snowboard boot heating using a renewable energy source that is both convenient and environmentally friendly.

### BRIEF DESCRIPTION OF THE DRAWING

The objects, advantages, and embodiment of the present invention will be clearly understood when considered in conjunction with the accompanying drawing, in which:

FIG. 1 is a simulated top view of a portion of the ski containing the solar cell clearly visible beneath the top sheet (cap) of the ski and also illustrating the potential circuit locations for transferring of electricity;

FIG. 2 is a cross section of the ski passing through the solar cell, depicting fundamentally how and where the addition of the solar cell and circuitry would appear in the ski cross section;

FIG. 3 is a partial side front view of the ski, boot, binding, and circuitry, all made transparent for illustration purposes, showing the electric circuit meeting the boot at the binding interface;

FIG. 4 is the exact type of partial view and transparency of FIG. 3, but of the rear binding.

FIG. 5 is a drawing of appearance of solar cells in a top view of a ski.

### DETAILED DESCRIPTION OF THE PREFERRED EMBODIMENT

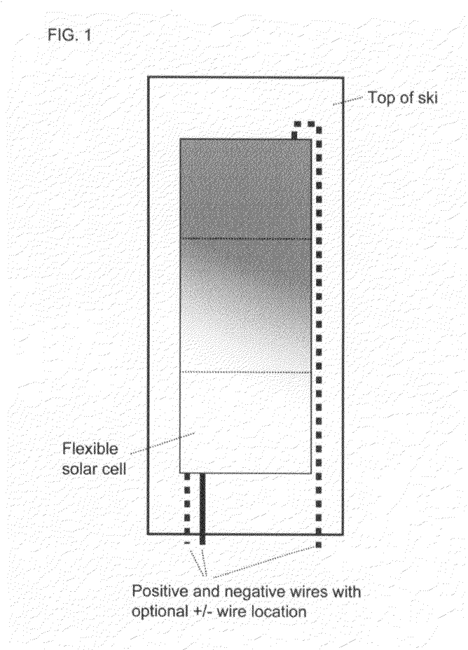

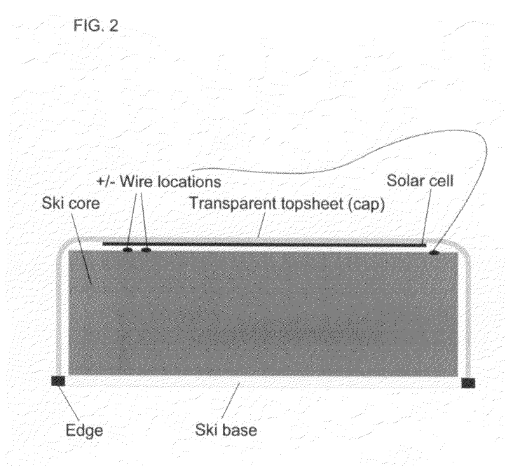

Referring to the solar panel illustrated in FIG. 1 it is shown how a flexible solar panel is placed within the top portion of the ski. In FIG. 2 it is further illustrated that the solar panel is placed beneath a transparent or translucent top sheet (commonly called the “cap”) of the ski for protection from abrasion and water and sealing of the delicate circuitry. From a manufacturing standpoint, the circuitry emerging from the bottom right hand corner of the cell in FIG. 1 indicates the location of the positive and negative circuits emanating from, and attached to, the positive and negative connection points on the solar cell. These circuits may be made of any type of wire with electrical capacity to safely carry current through the ski to the boot. These circuits may be placed in specially created notches or groves in the top of the ski's core which run to a connection point on the ski's surface where a binding will be mounted. This groove may be created if the bulk of the wire would create a bulge in the adhesive “sandwich” of the ski's structure, but is not specifically necessary.

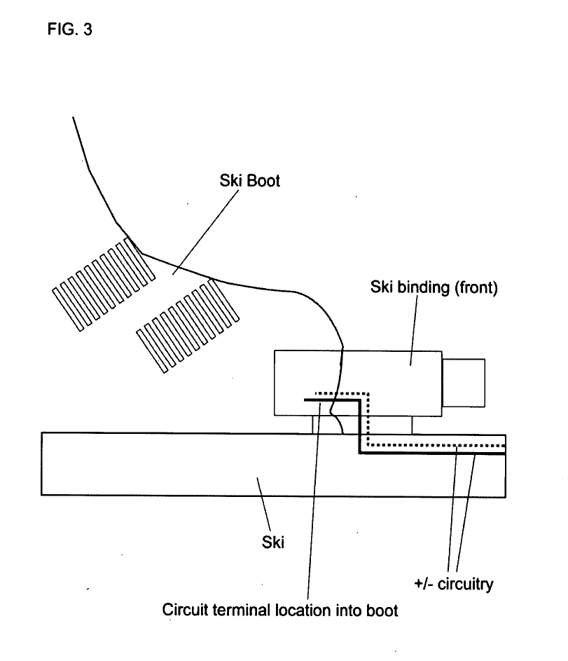

In FIG. 3 the circuitry illustrated in FIGS. 1 and 2 is continued on the right side of the drawing and within the structure of the ski. FIG. 3 then shows the circuitry angling up, toward the ski's surface. It meets the binding at the interface between the ski binding and the top surface of the ski. At this location, there will be some type of mounting hardware that is electrically conductive and separating the positive and negative currents as they enter the binding.

In FIG. 3 the circuitry is shown horizontally meeting up with the boot through the binding. At this point, there will be a connection point, be it magnetic, or plug-style, that makes a connection to the circuit once the boot is engaged into the binding. This connection may either be automatic, as the wearer steps in to the binding; or manual, as an exposed plug that emerges from the boot on one side, and the ski or binding on the other. Please note, at no point are we claiming a necessity of the circuit connection to exist either inside, or outside the binding/boot interface. It may be either or both. Although the illustration depicts the circuit running inside the binding to the boot we drew it this way as this is the preferred embodiment.

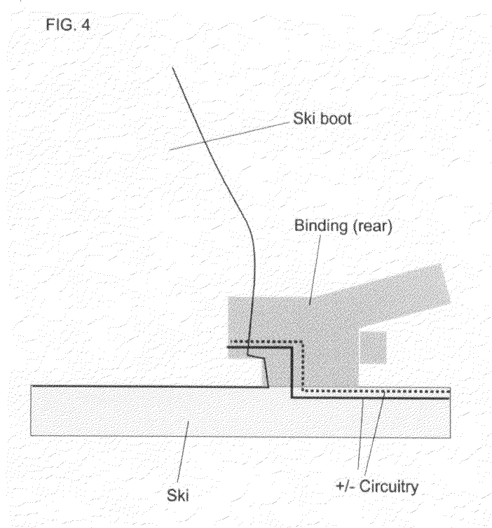

FIG. 4 is a replica in function of what has been described for FIG. 3, and is being provided to show the rear configuration of the same principle. Although we are not specifically claiming any thermostat temperature controller or heat tape involved in the use of this invention, it should be noted that they are obviously necessary for the implementation of this device. The temperature control and on/off switch may be located on either the boot or binding depending on the application of the invention. Technically speaking, although our invention ends at the boots' connection point into the binding, or boot to the ski or snowboard, the wiring must pass through a temperature controller with resistance at some point in the circuit, but again, as prior art has covered this along with heating elements inside of the boot, it is out of the scope of what is protectable by our patent.

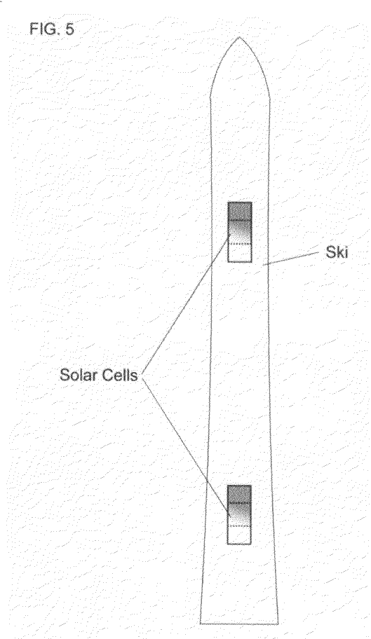

Lastly, FIG. 5 shows the appearance of the ski when viewed from the top before bindings have been mounted to it. This view illustrates the solar panels at the front and rear of the ski. More or less solar panels may be required, and can be run in tandem for even more power.

We claim:

1. An integrated electrical power system which comprises a ski or snowboard, a solar (photovoltaic) cell or group of solar (photovoltaic) cells, and electrical circuitry.

2. The structure of claim 1. Wherein said solar (photovoltaic) cell or group of solar (photovoltaic) cells are located within the structure of said ski or snowboard.

3. The structure of claim 1. Wherein said electrical circuitry is located within the structure of said ski or snowboard, connected to said solar cells, and designed to emerge from said ski or snowboard to meet at an electrical contact point of a ski or snowboard boot or binding.
